(19) United States
(12) Patent Application Publication
(10) Pub. No.: US 2016/0162416 A1
(43) Pub. Date: Jun. 9, 2016

(54) Apparatus and Method for Reducing Latency Between Host and a Storage Device

(71) Applicant: Intel Corporation, Santa Clara, OR (US)

(72) Inventors: James A. Boyd, Hillsboro, OR (US); Anand S. Ramalingam, Beaverton, OR (US); Pallav H. Gala, Hillsboro, OR (US); John W. Carroll, Gilbert, AZ (US); Richard P. Mangold, Forest Grove, OR (US)

(21) Appl. No.: 14/564,035

(22) Filed: Dec. 8, 2014

(51) Int. Cl. G06F 12/10; G06F 13/28

(52) U.S. Cl. CPC G06F 12/1081; G06F 13/28; G06F 2212/657

(57) ABSTRACT

Described is a system comprising: a storage device; a bus; and a host apparatus including a host memory and a driver module, wherein the host apparatus is coupled to the storage device via the bus, wherein the driver module is operable to: retrieve a logical to physical address mapping from the host memory; and provide the logical to physical address mapping to the storage device via the bus along with a read or write operation request. Described is a method comprising: retrieving a logical to physical address mapping from a host memory; and providing the logical to physical address mapping to a storage device via a bus along with a read or write operation request. Described is a machine readable storage medium having instructions stored thereon that, when executed, cause a machine to perform the method described above.

### BACKGROUND

When a storage device uses a Unified Host Memory (UHM), also referred to as Host Memory in a host system, to store its logical to physical mapping table, the storage device must fetch and/or update the data from the UHM for every request (i.e., read or write request). This process of fetching and/or updating the data between the UHM and the storage device results in many additional transactions (for example, data transfers) over a bus coupling the storage device and the host system. Such additional transactions over the bus add latency to the overall system, and thus lower the performance of the system.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a system having a host driver module for improving latency between a host and a storage device, according to some embodiments of the disclosure.

FIG. 2 illustrates a system performing a read operation with reduced latency between a host and a storage device, according to some embodiments of the disclosure.

FIG. 3 illustrates a Dword as defined in the Non-Volatile Memory Express (NVMe) specification.

FIG. 4A-C together illustrate a table using a larger command size for an NVMe command with physical address, according to some embodiments of the disclosure.

FIG. 5 illustrates a table showing a larger command completion indicator along with fields for physical address updates, according to some embodiments of the disclosure.

FIG. 6 illustrates a system performing a write operation with reduced latency between a host and a storage device, according to some embodiments of the disclosure.

FIG. 7 illustrates a flowchart of a method for reading from the storage device such that latency between the host and the storage device is reduced, according to some embodiments of the disclosure.

FIG. 8 illustrates a flowchart of a method for writing to the storage device such that latency between the host and the storage device is reduced, according to some embodiments of the disclosure.

FIG. 9 illustrates a smart device or a computer system or a SoC (System-on-Chip) with apparatus and/or machine readable instructions for reducing latency between the host and the storage device, according to some embodiments.

### DETAILED DESCRIPTION

In some embodiments, when a host driver has access to a unified memory (or UHM) residing in a host, the host driver is aware of a storage device's logical to physical address mapping stored in the UHM and may pass on that mapping information to the storage device upon request, where the storage device is coupled to the host via a bus. As such, latency for read and write operations between the storage device and the host is reduced because the number of transactions between the storage device and the host over the bus are reduced. Here, the term “host driver” generally refers to a software (e.g., device driver) or hardware module which is accessible by an operating system executing on the host, where the host driver allows the host to communicate with an external device (e.g., storage device). The host driver may also refer to a software module (e.g., device driver) that is part of an operating system executing on the host.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical or wireless connection between the things that are connected, without any intermediary devices. The term “coupled” means either a direct electrical or wireless connection between the things that are connected or an indirect connection through one or more passive or active intermediary devices. The term “circuit” means one or more passive and/or active components that are arranged to cooperate with one another to provide a desired function. The term “signal” means at least one current signal, voltage signal or data/clock signal. The meaning of “a,” “an,” and “the” include plural references. The meaning of “in” includes “in” and “on.”

The terms “substantially,” “close,” “approximately,” “near,” and “about,” generally refer to being within +/−20% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

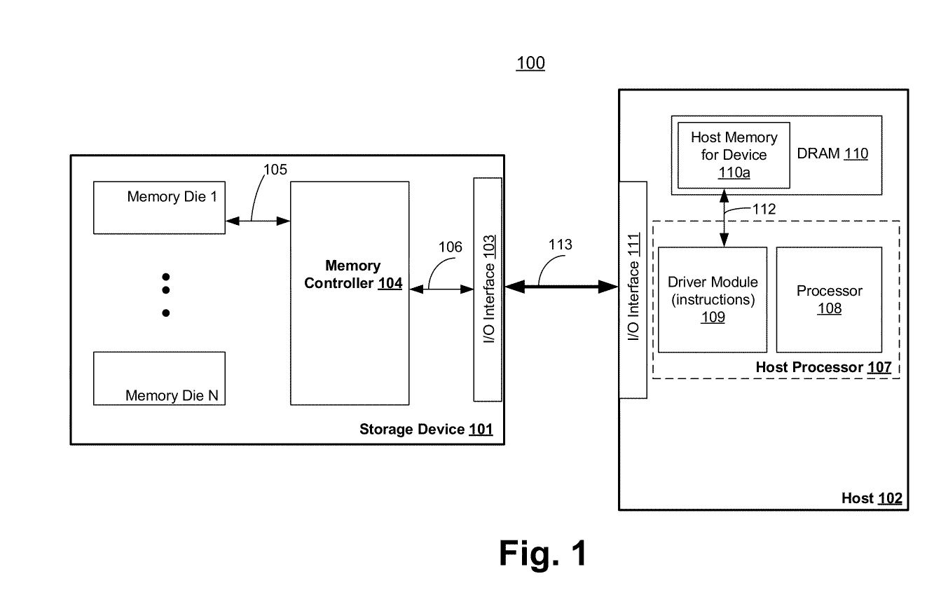

FIG. 1 illustrates system 100 having a host driver module for improving latency between a host and a storage device, according to some embodiments of the disclosure. In some embodiments, system 100 comprises Storage Device 101 and Host 102 having apparatus and/or modules to reduce latency between Storage Device 101 and Host 102. Here, the term “host driver module” generally refers to a software (e.g., device driver) or hardware module which is accessible by an operating system executing on Host 102, where the host driver module allows Host 102 to communicate with an external device (e.g., Storage Device 101). The “host driver module” may also refer to a software module (e.g., device driver) that is part of an operating system executing on Host 102.

In some embodiments, Storage Device 101 is a Solid State Drive (SSD). In other embodiments, other types of storage devices may be used. For example, Storage Device 101 may be a magnetic disk drive, or a tape drive, a volatile memory, etc. For the sake of explaining various embodiments, Storage Device 101 is assumed to be a SSD. In some embodiments, SSD 101 includes an Input/Output (I/O) interface 103, Memory Controller 104, and a plurality of memory dies (i.e., Memory Die 1 through Memory Die N, where N is an integer).

In some embodiments, I/O interface 103 is a Serial Advanced Technology Attachment (SATA) interface and interconnect 113 is a SATA compliant bus coupling SSD 101 to Host 102. In other embodiments, other types of I/O interfaces may be used for I/O interface 103. For example, Serial Attached Small Computer System Interface (SCSI) (or simply SAS) may be used for I/O interface 103, and interconnect 113 is a SAS compliant interface; Peripheral Component Interconnect Express (PCIe) may also be used for I/O interface 103 such as the one described by PCIe Base 3.0 Specification released Nov. 29, 2011.

In some embodiments, Memory Controller 104 communicates with Memory Dies 1 through N via channel 105. In some embodiments, channel 105 is an Open NAND Flash Interface (ONFI) specification compliant interface (e.g., ONFI Revision 4.0 released Apr. 2, 2014). In other embodiments, other types of interfaces may be used for communicating between Memory Controller 104 and Memory Dies.

Here, memory dies (i.e., Memory Die 1 to Memory Die N, where ‘N’ is an integer) are shown as a group of memory banks in one area. In some embodiments, the memory dies may be distributed in SSD 101. In some embodiments, each memory die is a non-volatile memory. For example, each memory die is one or more of a single or multi-threshold level NAND flash memory, NOR flash memory, single or multi-level Phase Change Memory (PCM), a three dimensional cross point memory, a resistive memory, nanowire memory, ferro-electric transistor random access memory (FeTRAM), magnetoresistive random access memory (MRAM) memory that incorporates memristor technology, or spin transfer torque (STT)-MRAM, or a combination of any of the above, etc.

So as not to obscure the embodiments, a simplified version of SSD 101 is shown. A person skilled in the art would appreciate that there are other logic and circuits needed for complete operation of SSD 101. For example, encoders, decoders, syndrome calculators, queues, input-output buffers, etc., are not shown.

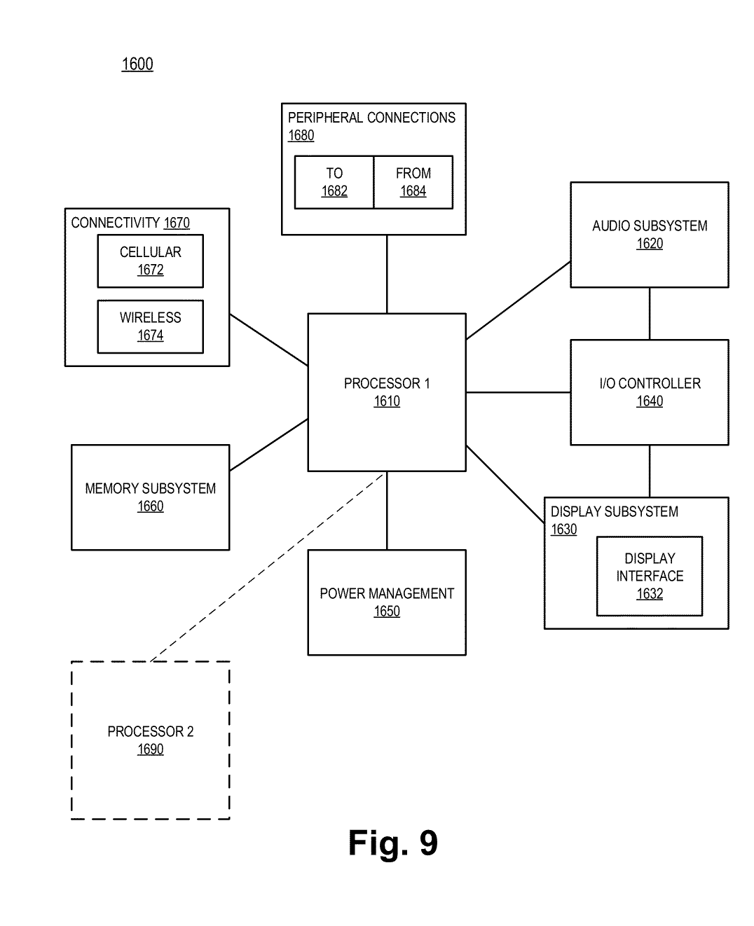

In some embodiments, Host 102 is any computing platform that can couple to Storage Device 101. In some embodiments, Host 102 comprises Host Processor 107 having Processor 108 and Driver Module (having computer executable instructions) 109, Dynamic Random Access Memory (DRAM) 110 having Host Memory 110a for Storage Device 101, and I/O interface 111. While various components of Host 102 are illustrated as separate components, they may be combined together in a single System-on-Chip (SoC). One such embodiment of a SoC is described with reference to FIG. 9.

Referring back to FIG. 1, while the embodiments of FIG. 1 are illustrated with respect to two distinct components in SSD 101 and Host 102, in some embodiments, SSD 101 and Host 102 can be packaged together as a single unit. In some embodiments, SSD 101 and Host 102 are implemented using a three dimensional integrated circuit (3D IC) technology where various dies are stacked on each other. For example, various dies or components of SSD 101 may be implemented as dies that are stacked on a die of Host 102 to form a stacked die or 3D IC.

In some embodiments, Processor 108 is a microprocessor (such as those designed by Intel Corporation of Santa Clara, Calif.), Digital Signal Processors (DSPs), Field-Programmable Gate Arrays (FPGAs), Application Specific Integrated Circuits (ASICs), or Radio-Frequency Integrated Circuits (RFICs), etc.

In some embodiments, Host Processor 107 communicates with memory 110 via an interface 112. In some embodiments, memory 110 is a Dynamic Random Access Memory (DRAM) 110, and interface 112 is a Double Data Rate compliant interface 112 as defined by the Joint Electron Device Engineering Council (JEDEC) Solid State Technology Association, published in September 2012. In other embodiments, other types of memories may be used. For explaining various embodiments, memory 110 is assumed to be a DRAM. In some embodiments, DRAM 110 includes Host Memory 110a for Storage Device 101. In some embodiments, Host Memory 110a stores logical to physical mapping table for Storage Device 101. This table is accessed upon a request (e.g., read or write requests) associated with Storage Device 101.

Instead of Storage Device 101 generating a Direct Memory Access (DMA) request to fetch data from Host Memory 110a (i.e., to access data from the logical to physical mapping table), in some embodiments, Driver Module 109 (also referred to as the host driver or the host driver module) reads the values from the table in Host Memory 110a and provides those values via I/O interface 111 to Storage Device 101 as part of the request (i.e., read or write request). In some embodiments, Driver Module 109 updates the table (i.e., the logical to physical mapping table) in Host Memory 110a for Storage Device 101 after read or write command or operation completes. In one such embodiment, Storage Device 101 may pass the updated address with the completion of the I/O operation (i.e., read or write operation) to Host 102, and Driver Module 109 then updates the mapping table directly.

Currently, storage devices fetch and update their logical to physical mapping table in the unified memory on every storage request. Such operation of fetching and updating add latency to the read and write operations. For example, the storage device has to issue an additional communication data transfer (or transaction) over the bus interconnecting the storage device and the host to retrieve the physical address of the request. Various embodiments described here eliminate these direct fetch and update transactions between Storage Device 101 and Unified Memory 110a, and so the latency and power consumption for the overall system (e.g., system 100) reduces.

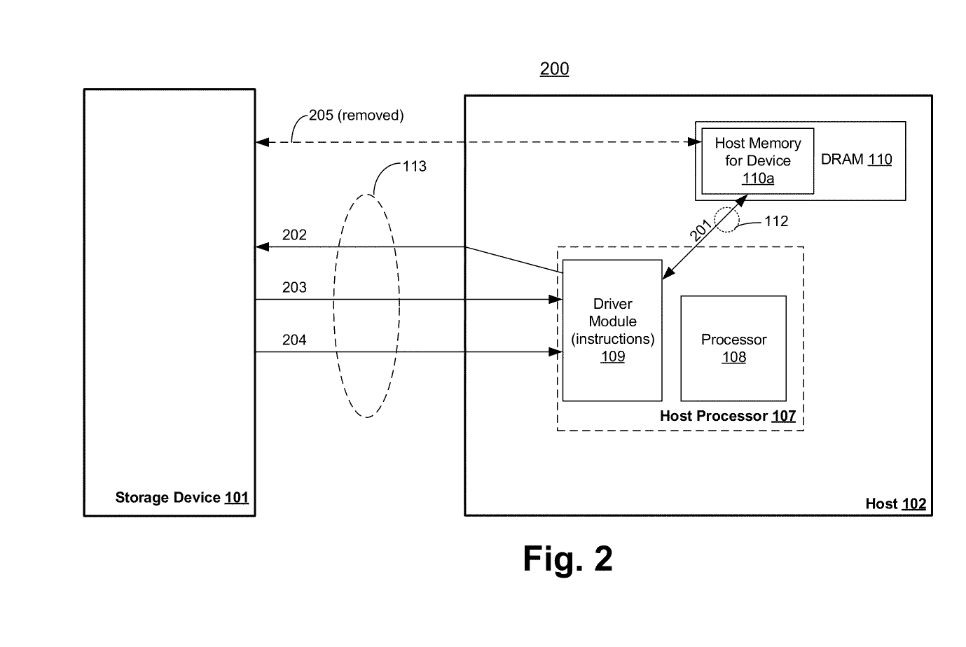

FIG. 2 illustrates system 200 performing a read operation resulting in reduced latency between Host 102 and Storage Device 101, according to some embodiments of the disclosure. It is pointed out that those elements of FIG. 2 having the same reference numbers (or names) as the elements of any other figure can operate or function in any manner similar to that described, but are not limited to such.

In some embodiments, when a read operation is performed by Host 102, Driver Module 109 retrieves logical to physical mapping from Host Memory 110a for Storage Device 101 instead of Storage Device 101 fetching the logical to physical mapping from Host Memory 110a as shown by the dotted line 205. As such, hardware in Storage Device 101 associated with initiating the fetch from Host Memory 110a can be removed according to some embodiments to save power and area.

In some embodiments, the messaging scheme between Driver Module 109 and Storage Device 101 is compliant to the Non-Volatile Memory Express (NVMe) specification. NVMe, or Non-Volatile Memory Host Controller Interface Specification (NVMHCI), is a specification for accessing SSDs attached through the PCIe bus. See, for example, NVM Express Revision 1.2 specification ratified on Nov. 3, 2014 and available for download at http://nvmexpress.org. One application of NVMe is SATA Express, which is a backward-compatible interface specification supporting either SATA or PCIe storage devices. SATA Express can use either legacy Advanced Host Controller Interface (AHCI) or a new NVMe compliant interface as the logical device interface.

In some embodiments, after retrieving the logical to physical mapping from Host Memory 110a for Storage Device 101, Driver Module 109 then issues a read I/O request to Driver Module 109 and also sends the logical to physical mapping along with the read I/O request as shown by message 202. In some embodiments, Storage Device 101 then retrieves data from one of the Memory Dies (1 through N) and returns the read data to Host 102 as shown by message 203.

In some embodiments, Storage Device 101 then sends a completion signal to Host 102 (i.e., to Driver Module 109) as shown by message 204. System 200 shows that, in some embodiments, host Driver Module 109 retrieves the physical address and supplies it to Storage Device 101 along with the read I/O request. This saves Storage Device 101 a messaging data transfer or transaction (hence improves latency) over bus 113 to access the physical address in Host Memory 110a (i.e., data transfer indicated by dashed line 205 is removed).

In some embodiments, Driver Module 109 and Storage Device 101 know in advance the logical to physical mapping (i.e., know the contents of the table in Host Memory 110a). In some embodiments, larger NVMe compliant command size, currently supported in the NVMe specification, may be used to send the read I/O request (or command) along with the physical address.

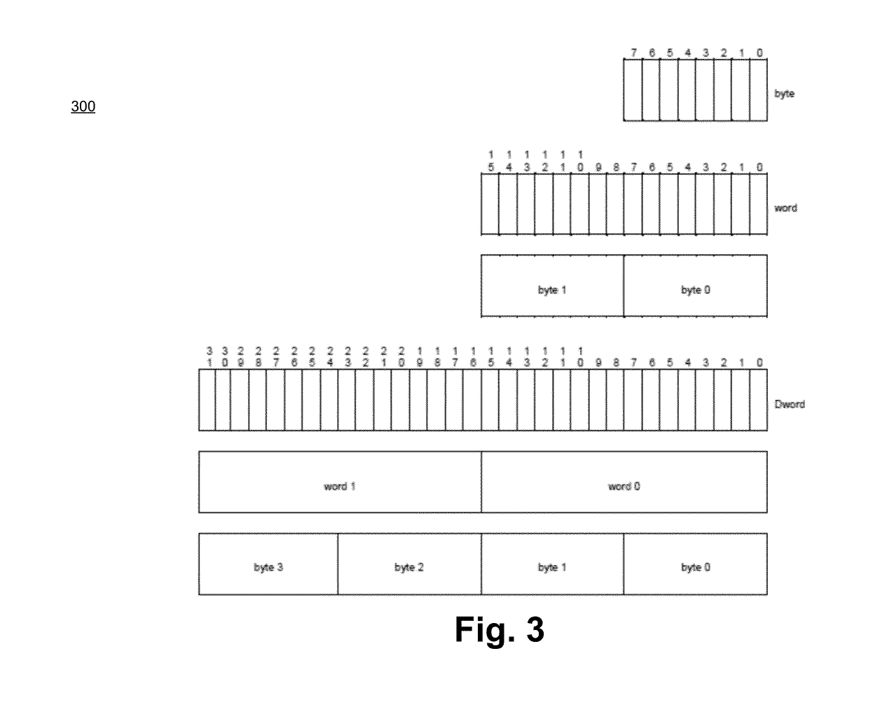

FIG. 3 illustrates a 32 bit DWORD 300 (that resides in memory) as defined in the NVMe specification. See, for example, NVMe Specification Revision 1.2 section 1.8 p. 18. In some embodiments, extra DWORDs (DWs) are used to pass the Logical/Physical address to/from Storage Device 101 and Host Device 102. DW is 32 bits of memory. Each NVMe command has multiple DWs that describe a command issued to the NVMe device. An NVMe device may allow for larger command sizes (thus more DWs can be sent per I/O). In some embodiments, within the larger commands, new DWs may contain the physical addresses. As such, in some embodiments, the physical addresses are passed with the I/O command (e.g., the read I/O request described with reference to FIG. 2).

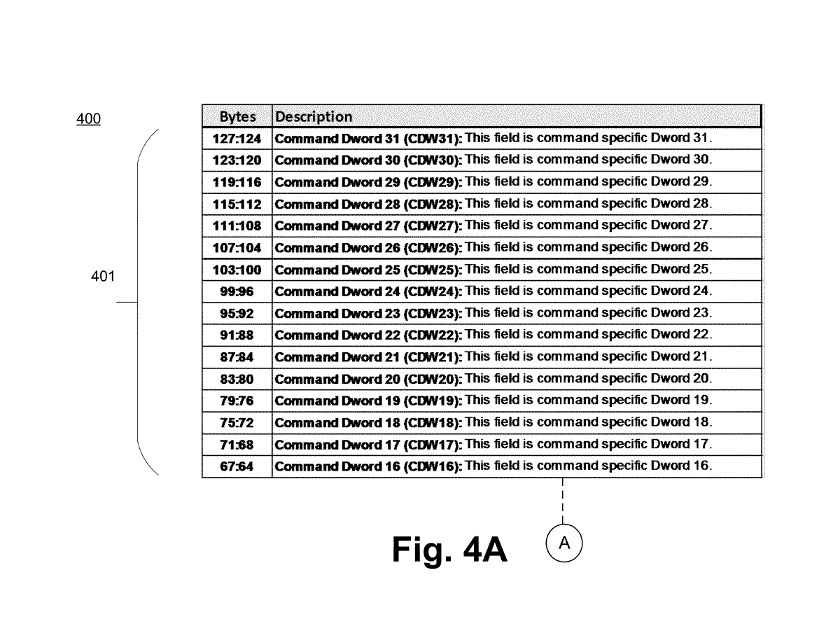

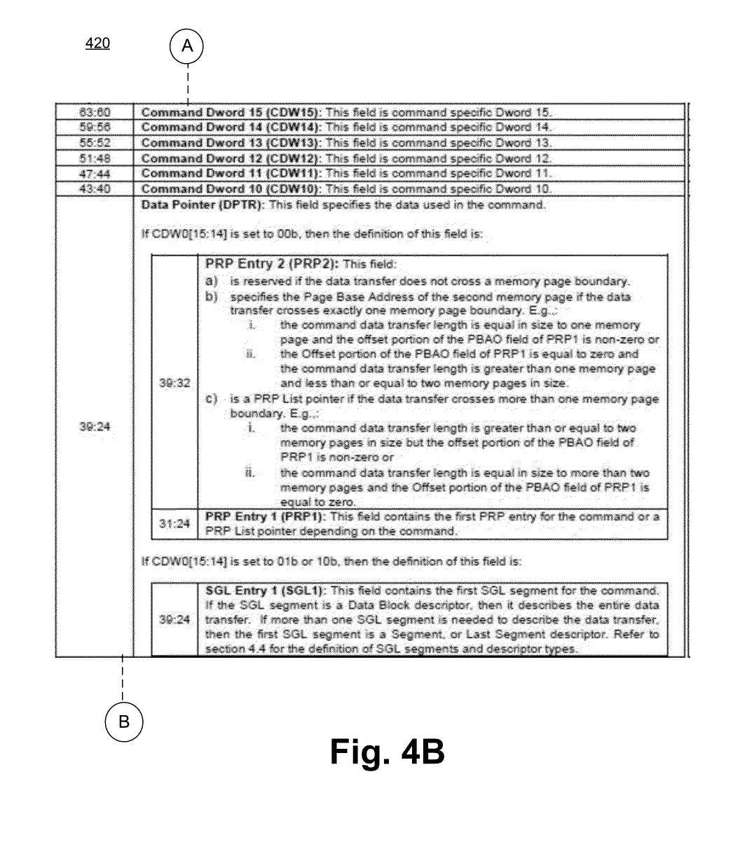

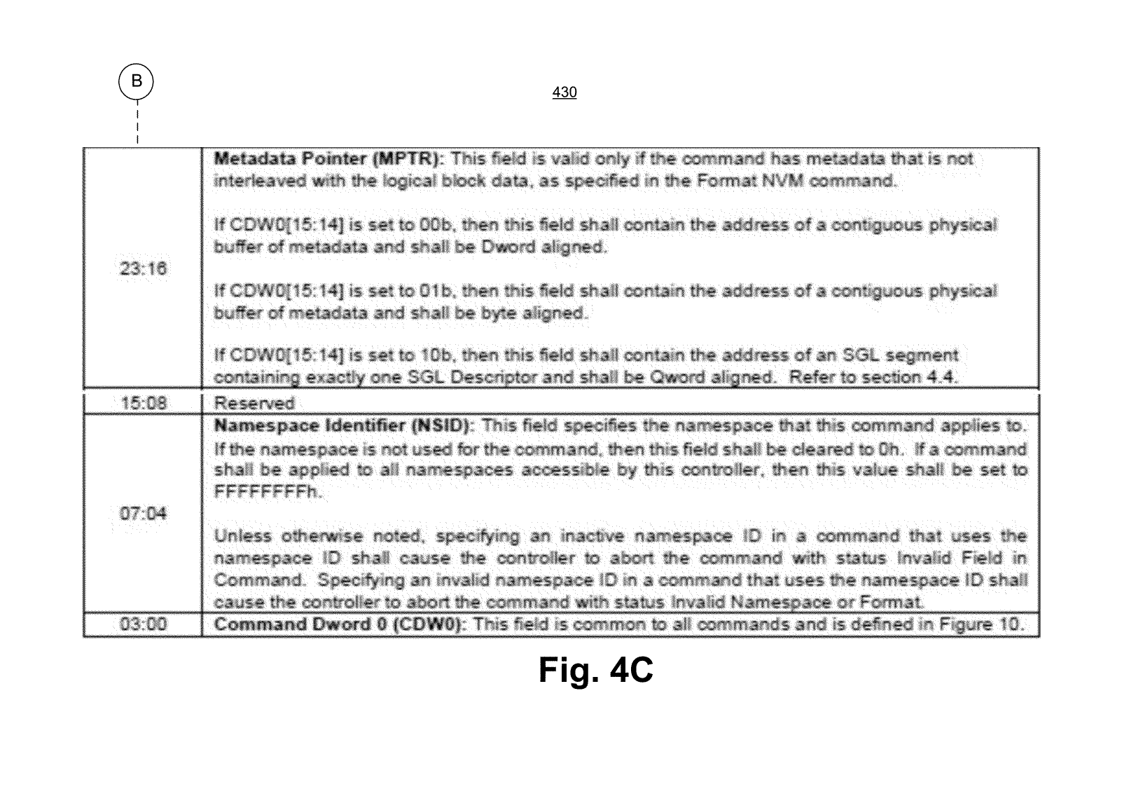

FIG. 4A-C together illustrate tables 400/420/430 using a larger command size for an NVMe command with physical address, according to some embodiments of the disclosure. Traditional command size for an NVMe command is 24 Bytes and is defined by byte fields, for example, byte fields 40:63 as described with reference to NVMe Specification Revision 1.2 section 1.8 p. 18. In some embodiments, additional byte fields 64:127 are added to the command size to pass the physical address. For example, in some embodiments, additional 64 bytes 401 are provided for passing the physical address along with read or write I/O commands.

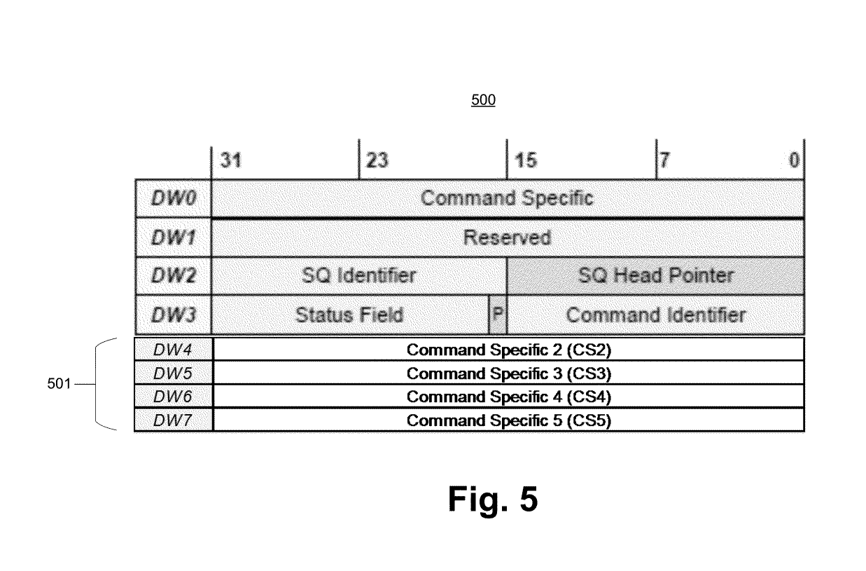

FIG. 5 illustrates table 500 showing a larger command completion indicator along with fields for physical address updates, according to some embodiments of the disclosure. Traditional command completion for an NVMe command is defined by four DWs (See, for example, NVMe Specification Revision 1.2 section 14.6 p. 61). In some embodiments, additional four DWs can be concatenated to the traditional command completion to provide fields for the physical address update.

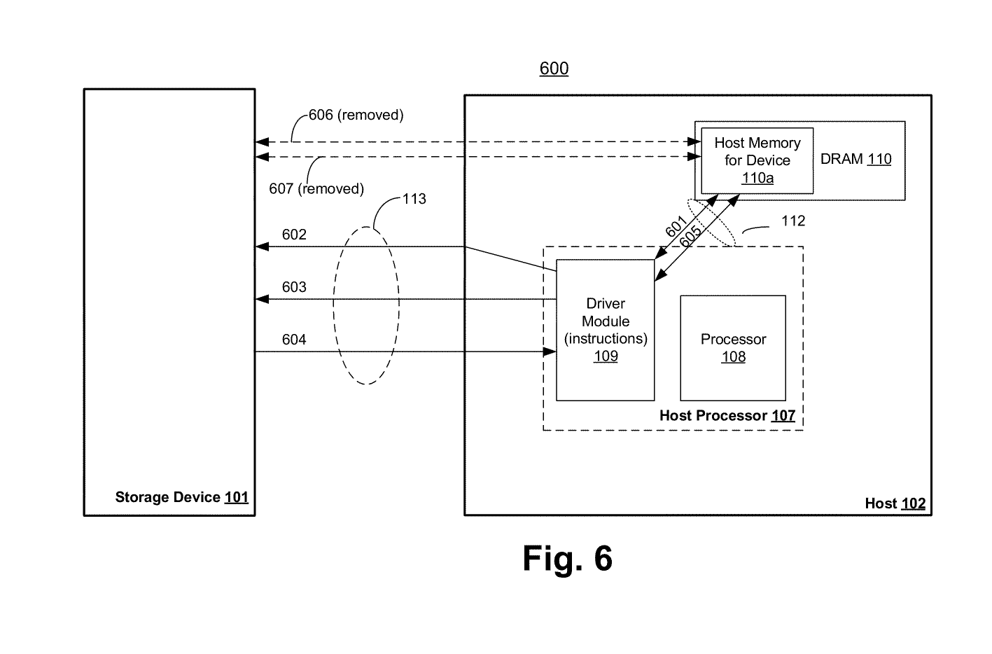

FIG. 6 illustrates system 600 performing a write operation which results in reduced latency between Host 102 and Storage Device 101, according to some embodiments of the disclosure. It is pointed out that those elements of FIG. 6 having the same reference numbers (or names) as the elements of any other figure can operate or function in any manner similar to that described, but are not limited to such.

In some embodiments, when Host 102 initiates a write operation request (i.e., wants to write to Storage Device 101), Driver Module 109 retrieves logical to physical mapping from Host Memory 110a for Storage Device 101 instead of Storage Device 101 fetching the logical to physical mapping from Host Memory 110a as shown by the dotted line 606. As such, hardware in Storage Device 101 associated with initiating the fetch from Host Memory 110a can be removed according to some embodiments to save power and area.

In some embodiments, after retrieving the logical to physical mapping from Host Memory 110a for Storage Device 101, Driver Module 109 then issues the write I/O request to Driver Module 109 and also sends the logical to physical mapping along with the write I/O request as shown by message 602. In some embodiments, after sending message 602, Driver Module 109 sends the data for writing to one or more of Memory Dies (1 through N) to Storage Device 101.

After successfully storing the data in the Memory Dies, Storage Device 101 sends a signal indicating completion of the write operation along with the updated physical address to Host 102 (i.e., to Driver Module 109). For example, Storage Device 101 sends an NVMe signal such as the Message Signaled interrupt along with the completed command, command completion status (i.e., Phase bit status), and updated physical addresses to Host 102 as described with reference to FIG. 5.

Referring back to FIG. 6, in some embodiments, Driver Module 109 then updates the logical to physical mapping (according to the received updated physical address) table in Host Memory 110. This process saves the extra messaging (to transactions) 607 between Storage Device 101 and Host Memory 110a. The embodiments here save at least two communication data transfers (illustrated as dashed lines 606 and 607) between Storage Device 101 and Host 102. This results in reduced latency, lower power consumption, and higher performance for system 600 compared to traditional schemes.

In some embodiments, Driver Module 109 and Storage Device 101 know in advance the logical to physical mapping (i.e., know the contents of the table in Host Memory 110a). In some embodiments, larger NVMe compliant command and completion sizes, currently supported in the NVMe specification, may be used to send the write I/O request (or command) along with the physical address, and to receive the signal completion along with the updated physical address. In some embodiments, the extra DWs (as defined in the NVMe specification) are used to pass the Logical/Physical address to/from Storage Device 101 and Host Device 102 as described with reference to FIGS. 4-5.

Referring back to FIG. 6, in a traditional scheme, a storage device retrieves the physical address of the write I/O request from Host Memory 110a in case the logical address in Host Memory 110a is already in use, and after writing the data to one or more of the Memory Dies as shown by message transaction 206. In traditional schemes, the storage device also communicates with Host Memory 110a to invalidate the previous physical address and update the logical to physical mapping table with the new physical address of the data as shown by message transaction 607. By eliminating these communication message transactions (as shown by message transactions 606 and 607), latency is reduced, power consumption is lowered, and performance is improved for system 600.

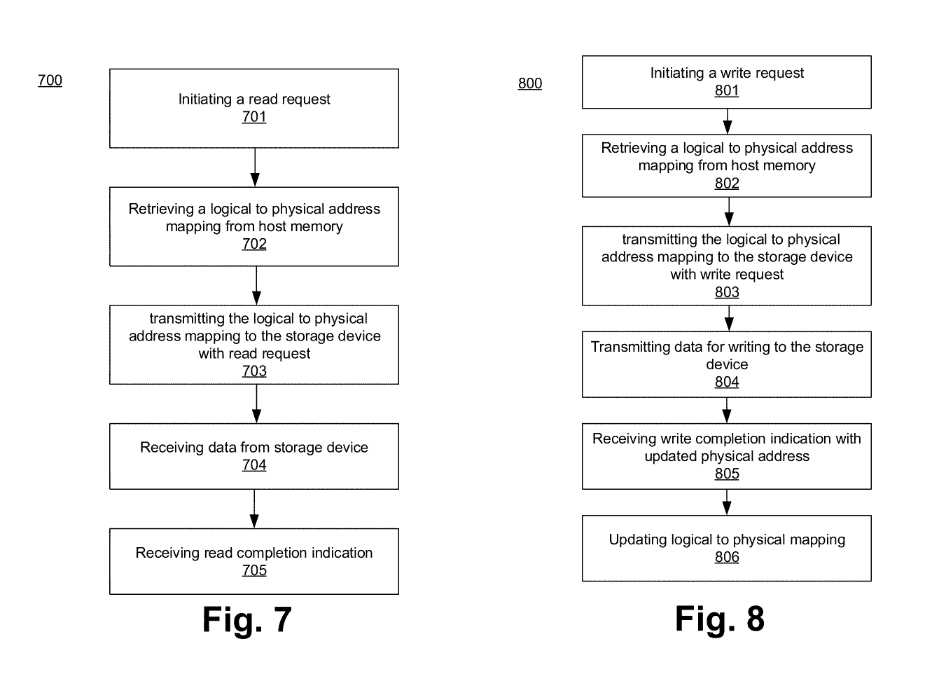

FIG. 7 illustrates flowchart 700 of a method for reading from the storage device such that latency between the host and the storage device is reduced, according to some embodiments of the disclosure. It is pointed out that those elements of FIG. 7 having the same reference numbers (or names) as the elements of any other figure can operate or function in any manner similar to that described, but are not limited to such.

Although the blocks in the flowchart with reference to FIG. 7 are shown in a particular order, the order of the actions can be modified. Thus, the illustrated embodiments can be performed in a different order, and some actions/blocks may be performed in parallel. Some of the blocks and/or operations listed in FIG. 7 are optional in accordance with certain embodiments. The numbering of the blocks presented is for the sake of clarity and is not intended to prescribe an order of operations in which the various blocks must occur. Additionally, operations from the various flows may be utilized in a variety of combinations.

At block 701, Host 102 initiates a read request (i.e., Host 102 desires to read data from Storage Device 101). At block 702, Driver Module 109 retrieves a logical to physical address mapping from a table in Host Memory 110a. At block 703, Driver Module 109 instructs I/O interface 111 to transmit the logical to physical address mapping that it received from the table to Storage Device 101 along with the read I/O request.

At block 704, Storage Device 101 processes the read I/O request, For example, Memory Controller 104 retrieves data from one or more memory dies, decodes the data (which is generally encoded for error correction purposes), and sends that data to Host 102 via interface 103. At block 704, Host 102 receives the data from Storage Device 101 in response to the read I/O request. At block 705, Driver Module 109 receives an indication from Storage Device 101 that the read operation is completed. Process 700 saves Storage Device 101 a communication data transfer or transaction (hence improves latency) over bus 113 to the physical address in Host Memory 110a (i.e., data transfer indicated by dashed line 205 is removed), according to some embodiments.

FIG. 8 illustrates flowchart 800 of a method for writing to the storage device such that latency between the host and the storage device is reduced, according to some embodiments of the disclosure. It is pointed out that those elements of FIG. 8 having the same reference numbers (or names) as the elements of any other figure can operate or function in any manner similar to that described, but are not limited to such.

Although the blocks in the flowchart with reference to FIG. 8 are shown in a particular order, the order of the actions can be modified. Thus, the illustrated embodiments can be performed in a different order, and some actions/blocks may be performed in parallel. Some of the blocks and/or operations listed in FIG. 8 are optional in accordance with certain embodiments. The numbering of the blocks presented is for the sake of clarity and is not intended to prescribe an order of operations in which the various blocks must occur. Additionally, operations from the various flows may be utilized in a variety of combinations.

At block 801, Host 102 initiates a write request (i.e., Host 102 desires to write data to Storage Device 101). At block 802, Driver Module 109 retrieves a logical to physical address mapping from a table in Host Memory 110a. At block 803, Driver Module 109 sends or transmits via interface 111 the logical to physical address mapping that it retrieved to Storage Device 101 along with the write I/O request. At block 804, Host 102 transmits the data to be written to Storage Device 101. In some embodiments, Storage Device 101 receives data and encodes it with an error correction code (ECC) and then writes that encoded data to one or more Memory Dies 1 through N. Data encoding may be performed by Memory Controller 104.

At block 805, after Storage Device 101 successfully writes data to one or more Memory Dies 1 though N, Storage Device 101 sends a write completion indication to Host 102 along with the updated physical address (to update the table in Host Memory 110a). Once Host 102 receives the write completion indication and the updated physical address associated with the newly written data, at block 806, Driver Module 109 updates the local to physical mapping address in the table in Host Memory 110a.

Process 800 saves at least two communication data transfers or transactions (illustrated as dashed lines 606 and 607 in FIG. 6) between Storage Device 101 and Host 102. This results in reduced latency, lower power consumption, and higher performance compared to traditional write operation schemes.

Program software code/instructions associated with flowcharts 700 and 800 executed to implement embodiments of the disclosed subject matter may be implemented as part of Driver Module 109, operating system or a specific application, component, program, object, module, routine, or other sequence of instructions or organization of sequences of instructions referred to as “program software code/instructions,” “operating system program software code/instructions,” “application program software code/instructions,” or simply “software.”

In some embodiments, these software code/instructions (also referred to as machine or computer executable instructions) are stored in a computer or machine executable storage medium. Computer or machine executable storage medium is a tangible machine readable medium that can be used to store program software code/instructions and data that, when executed by a computing device, cause a processor to perform method(s) 700 and/or 800 as may be recited in one or more accompanying claims directed to the disclosed subject matter.

The tangible machine readable medium may include storage of the executable software program code/instructions and data in various tangible locations, including for example ROM, volatile RAM, non-volatile memory and/or cache and/or other tangible memory as referenced in the present application. Portions of this program software code/instructions and/or data may be stored in any one of these storage and memory devices. Further, the program software code/instructions can be obtained from other storage, including, e.g., through centralized servers or peer to peer networks and the like, including the Internet. Different portions of the software program code/instructions and data can be obtained at different times and in different communication sessions or in a same communication session.

The software program code/instructions and data can be obtained in their entirety prior to the execution of a respective software program or application by the computing and other removable disks, magnetic disk storage media, optical storage media (e.g., Compact Disk Read-Only Memory (CD ROMS), Digital Versatile Disks (DVDs), etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, a tangible machine readable medium includes any tangible mechanism that provides (i.e., stores and/or transmits in digital form, e.g., data packets) information in a form accessible by a machine (i.e., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Blackberry® Droid®, or the like, or any other device including a computing device. In one embodiment, a processor-based system is in a form of or included within a PDA, a cellular phone, a notebook computer, a tablet, a game console, a set top box, an embedded system, a TV, a personal desktop computer, etc. Alternatively, the traditional communication applications and subsidized application(s) may be used in some embodiments of the disclosed subject matter.

FIG. 9 illustrates a smart device or a computer system or a SoC with apparatus and/or machine readable instructions for reducing latency between the host and the storage device, according to some embodiments. It is pointed out that those elements of FIG. 9 having the same reference numbers (or names) as the elements of any other figure can operate or function in any manner similar to that described, but are not limited to such.

In this example, Host 102 and Storage Device 101 are integrated in one system as a smart device or a computer system or a SoC, such that Host 102 includes the apparatus and/or machine readable instructions for reducing latency between Host 102 and Storage Device 101, according to some embodiments. FIG. 9 illustrates a block diagram of an embodiment of a mobile device in which flat surface interface connectors could be used. In some embodiments, computing device 1600 represents a mobile computing device, such as a computing tablet, a mobile phone or smart-phone, a wireless-enabled e-reader, or other wireless mobile device. It will be understood that certain components are shown generally, and not all components of such a device are shown in computing device 1600.

In some embodiments, computing device 1600 includes a first processor 1610 (e.g., Host processor 107) with apparatus and/or machine readable instructions 109 for reducing latency between first processor 1610 and memory subsystem 1660 (i.e., storage device), according to some embodiments discussed. The various embodiments of the present disclosure may also comprise a network interface within 1670 such as a wireless interface so that a system embodiment may be incorporated into a wireless device, for example, cell phone or personal digital assistant.

In some embodiments, first processor 1610 (and/or second processor 1690) can include one or more physical devices, such as microprocessors, application processors, microcontrollers, programmable logic devices, or other processing means. The processing operations performed by processor 1610 include the execution of an operating platform or operating system on which applications and/or device functions are executed. The processing operations include operations related to I/O (input/output) with a human user or with other devices, operations related to power management, and/or operations related to connecting the computing device 1600 to another device. The processing operations may also include operations related to audio I/O and/or display I/O.

In some embodiments, computing device 1600 includes audio subsystem 1620, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 1600, or connected to the computing device 1600. In one embodiment, a user interacts with the computing device 1600 by providing audio commands that are received and processed by processor 1610.

In some embodiments, computing system 1600 includes display subsystem 1630. Display subsystem 1630 represents hardware (e.g., display devices) and software (e.g., drivers) components that provide a visual and/or tactile display for a user to interact with the computing device 1600. Display subsystem 1630 includes display interface 1632, which includes the particular screen or hardware device used to provide a display to a user. In one embodiment, display interface 1632 includes logic separate from processor 1610 to perform at least some processing related to the display. In one embodiment, display subsystem 1630 includes a touch screen (or touch pad) device that provides both output and input to a user.

In some embodiments, computing device 1600 includes I/O controller 1640. I/O controller 1640 represents hardware devices and software components related to interaction with a user. I/O controller 1640 is operable to manage hardware that is part of audio subsystem 1620 and/or display subsystem 1630. Additionally, I/O controller 1640 illustrates a connection point for additional devices that connect to computing device 1600 through which a user might interact with the system. For example, devices that can be attached to the computing device 1600 might include microphone devices, speaker or stereo systems, video systems or other display devices, keyboard or keypad devices, or other I/O devices for use with specific applications such as card readers or other devices.

As mentioned above, I/O controller 1640 can interact with audio subsystem 1620 and/or display subsystem 1630. For example, input through a microphone or other audio device can provide input or commands for one or more applications or functions of the computing device 1600. Additionally, audio output can be provided instead of, or in addition to display output. In another example, if display subsystem 1630 includes a touch screen, the display device also acts as an input device, which can be at least partially managed by I/O controller 1640. There can also be additional buttons or switches on the computing device 1600 to provide I/O functions managed by I/O controller 1640.

In some embodiments, I/O controller 1640 manages devices such as accelerometers, cameras, light sensors or other environmental sensors, or other hardware that can be included in the computing device 1600. The input can be part of direct user interaction, as well as providing environmental input to the system to influence its operations (such as filtering for noise, adjusting displays for brightness detection, applying a flash for a camera, or other features).

In some embodiments, computing device 1600 includes power management 1650 that manages battery power usage, charging of the battery, and features related to power saving operation.

In some embodiments, computing device 1600 includes memory subsystem 1660 (e.g., Storage Device 101). Memory subsystem 1660 includes memory devices for storing information in computing device 1600. Memory can include nonvolatile (state does not change if power to the memory device is interrupted) and/or volatile (state is indeterminate if power to the memory device is interrupted) memory devices. Memory subsystem 1660 can store application data, user data, music, photos, documents, or other data, as well as system data (whether long-term or temporary) related to the execution of the applications and functions of the computing device 1600.

Elements of embodiments are also provided as a machine-readable medium (e.g., memory 1660) for storing the computer-executable instructions (e.g., instructions to implement any other processes discussed herein). The machine-readable medium (e.g., memory 1660) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, computing device 1600 includes connectivity 1670. Connectivity 1670 includes hardware devices (e.g., wireless and/or wired connectors and communication hardware) and software components (e.g., drivers, protocol stacks) to enable the computing device 1600 to communicate with external devices. The computing device 1600 could be separate devices, such as other computing devices, wireless access points or base stations, as well as peripherals such as headsets, printers, or other devices.

In some embodiments, connectivity 1670 can include multiple different types of connectivity. To generalize, the computing device 1600 is illustrated with cellular connectivity 1672 and wireless connectivity 1674. Cellular connectivity 1672 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 1674 refers to wireless connectivity that is not cellular, and can include personal area networks (such as Bluetooth, Near Field, etc.), local area networks (such as Wi-Fi), and/or wide area networks (such as WiMax), or other wireless communication.

In some embodiments, computing device 1600 includes peripheral connections 1680. Peripheral connections 1680 include hardware interfaces and connectors, as well as software components (e.g., drivers, protocol stacks) to make peripheral connections. It will be understood that the computing device 1600 could both be a peripheral device (“to” 1682) to other computing devices, as well as have peripheral devices (“from” 1684) connected to it. The computing device 1600 commonly has a “docking” connector to connect to other computing devices for purposes such as managing (e.g., downloading and/or uploading, changing, synchronizing) content on computing device 1600. Additionally, a docking connector can allow computing device 1600 to connect to certain peripherals that allow the computing device 1600 to control content output, for example, to audiovisual or other systems.

In addition to a proprietary docking connector or other proprietary connection hardware, the computing device 1600 can make peripheral connections 1680 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

For example, a system is provided which comprises: a storage device; a bus; and a host apparatus including a host memory and a driver module, wherein the host apparatus is coupled to the storage device via the bus, wherein the driver module is operable to: retrieve a logical to physical address mapping from the host memory; and provide the logical to physical address mapping to the storage device via the bus along with a read or write operation request. In some embodiments, the driver module is operable to receive a new physical address from the storage device. In some embodiments, the driver module is operable to: update a logical to physical mapping, associated with the new physical address, in the host memory.

In some embodiments, driver module is operable to update the logical to physical mapping in response to receiving a signal from the storage device that the write operation is complete. In some embodiments, the storage device stores its physical to logical mapping table in the host memory. In some embodiments, the bus is one of: a PCIe compliant bus; SATA compliant bus; or a SCSI compliant bus. In some embodiments, the storage device is one or more of: a NAND flash memory, a NOR flash memory, a PCM, a three dimensional cross point memory, a resistive memory, nanowire memory, a FeTRAM, a MRAM that incorporates memristor technology, or a STT-MRAM. In some embodiments, the host memory is a DRAM. In some embodiments, the host apparatus comprises a processor coupled to the DRAM via a DDR compliant interface.

In another example, a machine readable storage medium having instructions stored thereon that, when executed, cause a machine to perform a method comprising: retrieving a logical to physical address mapping from a host memory; and providing the logical to physical address mapping to a storage device via a bus along with a read or write operation request. In some embodiments, the machine readable storage medium has further instructions stored thereon that, when executed, cause the machine to perform a further method comprising: receiving a new physical address from the storage device.

In some embodiments, the machine readable storage medium has further instructions stored thereon that, when executed, cause the machine to perform a further method comprising: updating a logical to physical mapping, associated with the new physical address, in the host memory. In some embodiments, wherein updating the logical to physical mapping is in response to receiving a signal from the storage device that the write operation is complete. In some embodiments, the bus is one of: a PCIe compliant bus; SATA compliant bus; or a SCSI compliant bus. In some embodiments, the storage device is one or more of: a NAND flash memory, a NOR flash memory, a PCM, a three dimensional cross point memory, a resistive memory, nanowire memory, a FeTRAM, a MRAM that incorporates memristor technology, or a STT-MRAM. In some embodiments, the host memory is a dynamic random access memory (DRAM). In some embodiments, the storage device stores its physical to logical mapping table in the host memory.

In another example, a method is provided which comprises: retrieving a logical to physical address mapping from a host memory; and transmitting the logical to physical address mapping to a storage device via a bus along with a read or write operation request. In some embodiments, the method comprises: receiving a new physical address from the storage device; and updating a logical to physical mapping, associated with the new physical address, in the host memory. In some embodiments, updating the logical to physical mapping is in response to receiving a signal from the storage device that the write operation is complete.

In another example, an apparatus is provided means for retrieving a logical to physical address mapping from a host memory; and means for providing the logical to physical address mapping to a storage device via a bus along with a read or write operation request. In some embodiments, the apparatus comprises: means for receiving a new physical address from the storage device. In some embodiments, the apparatus comprises: means for updating a logical to physical mapping, associated with the new physical address, in the host memory. In some embodiments, the means for updating the logical to physical mapping is in response to receiving a signal from the storage device that the write operation is complete.

In some embodiments, the bus is one of: a PCIe compliant bus; SATA compliant bus; or a SCSI compliant bus. In some embodiments, the storage device is one or more of: a NAND flash memory, a NOR flash memory, a PCM, a three dimensional cross point memory, a resistive memory, nanowire memory, a FeTRAM, a MRAM that incorporates memristor technology, or a STT-MRAM. In some embodiments, the host memory is a dynamic random access memory (DRAM). In some embodiments, the storage device stores its physical to logical mapping table in the host memory.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. A system comprising:
a storage device;
a bus; and
a host apparatus including a host memory and a driver module, wherein the host apparatus is coupled to the storage device via the bus, wherein the driver module is operable to:
retrieve a logical to physical address mapping from the host memory; and
provide the logical to physical address mapping to the storage device via the bus along with a read or write operation request.

2. The system of claim 1, wherein the driver module is operable to:
receive a new physical address from the storage device.

3. The system of claim 2, wherein the driver module is operable to:
update a logical to physical mapping, associated with the new physical address, in the host memory.

4. The system of claim 3, wherein driver module is operable to update the logical to physical mapping in response to receiving a signal from the storage device that the write operation is complete.

5. The system of claim 1, wherein the storage device stores its physical to logical mapping table in the host memory.

6. The system of claim 1, wherein the bus is one of:
a Peripheral Component Interconnect Express (PCIe) compliant bus;
a Serial ATA (SATA) compliant bus; or
a Serial Attached Small Computer System Interface (SCSI) compliant bus.

7. The system of claim 1, wherein the storage device is one or more of:
a NAND flash memory,
a NOR flash memory,
a Phase Change Memory (PCM),
a three dimensional cross point memory,
a resistive memory, nanowire memory,
a ferro-electric transistor random access memory (FeTRAM),
a magnetoresistive random access memory (MRAM) memory that incorporates memristor technology, or
a spin transfer torque (STT)-MRAM.

8. The system of claim 1, wherein the host memory is a dynamic random access memory (DRAM).

9. The system of claim 8, wherein the host apparatus comprises a processor coupled to the DRAM via a Double Data Rate (DDR) compliant interface.

10. A machine readable storage medium having instructions stored thereon that, when executed, cause a machine to perform a method comprising:
retrieving a logical to physical address mapping from a host memory; and
providing the logical to physical address mapping to a storage device via a bus along with a read or write operation request.

11. The machine readable storage medium of claim 10, having further instructions stored thereon that, when executed, cause the machine to perform a further method comprising:
receiving a new physical address from the storage device.

12. The machine readable storage medium of claim 11, having further instructions stored thereon that, when executed, cause the machine to perform a further method comprising:
updating a logical to physical mapping, associated with the new physical address, in the host memory.

13. The machine readable storage medium of claim 12, wherein updating the logical to physical mapping is in response to receiving a signal from the storage device that the write operation is complete.

14. The machine readable storage medium of claim 10, wherein the bus is one of:
a Peripheral Component Interconnect Express (PCIe) compliant bus;
a Serial ATA (SATA) compliant bus; or
a Serial Attached Small Computer System Interface (SCSI) compliant bus.

15. The machine readable storage medium of claim 10, wherein the storage device is one or more of:
a NAND flash memory,
a NOR flash memory,
a Phase Change Memory (PCM),
a three dimensional cross point memory,
a resistive memory, nanowire memory,
a ferro-electric transistor random access memory (FeTRAM),
a magnetoresistive random access memory (MRAM) memory that incorporates memristor technology, or
a spin transfer torque (STT)-MRAM.

16. The machine readable storage medium of claim 10, wherein the host memory is a dynamic random access memory (DRAM).

17. The machine readable storage medium of claim 10, wherein the storage device stores its physical to logical mapping table in the host memory.

18. A method comprising:
retrieving a logical to physical address mapping from a host memory; and
transmitting the logical to physical address mapping to a storage device via a bus along with a read or write operation request.

19. The method of claim 18 comprising:
receiving a new physical address from the storage device; and
updating a logical to physical mapping, associated with the new physical address, in the host memory.

20. The method of claim 19, wherein updating the logical to physical mapping is in response to receiving a signal from the storage device that the write operation is complete.
